(19) United States
(12) Patent Application Publication
(10) Pub. No.: US 2011/0145979 A1
(43) Pub. Date: Jun. 23, 2011

(54) RIBBON FOR HEAT-SEALING

(75) Inventor: Pietro Degni, Paderno Dugnano (IT)

(73) Assignee: FRA-SER S.P.A., 20129 MILANO (MI) (IT)

(21) Appl. No.: 13/054,878

(22) PCT Filed: Jul. 13, 2009
(86) PCT No.: PCT/IB2009/053032

§ 371 Date: Mar. 9, 2011

(30) Foreign Application Priority Data
Jul. 28, 2008 (IT) MI2008A001385

(51) Int. Cl. A41D 27/08; B32B 3/00; B32B 37/00

(52) U.S. Cl. 2/244; 428/172; 156/60

(57) ABSTRACT

A ribbon for heat-sealing of fabrics has been made which comprises a thin-sheet support (2) of a polyurethane-based material suitable to be heat-sealed to a fabric; at an upper face (2b) of the support, laying of at least one layer (3) of a silicone-based material is provided, said layer being in the form of one or more continuous or interrupted strips extending along the same extension as the ribbon.

The present invention relates to a ribbon for heat-sealing of fabrics, a method of producing said ribbon and the garment utilising the same.

In particular, the ribbon being the object of the present invention falls within the sector involving heat-sealing of ribbons to textiles or fabrics in order to carry out junctions or trimming operations on the fabrics without use of seams.

It is known that there are presently on the market different garments or fabrics having trimmings or junction regions in which they are joined to other fabric portions by use of particular iron-on ribbons suitable to be heat-sealed to the fabric.

These ribbons enable seams or use of glues to be avoided for mutually connecting the fabric portions, or they are also used for reinforcing existing seams thus giving rise to a softer, covered seam or a seam where the edge fraying is prevented.

Generally, ribbons used for enabling the above operations consist of a thin strip of an elastic material adapted to be heat-sealed to fabric edges.

For carrying out this type of working, suitable machines are used that couple and heat the ribbon and fabric regions to be joined.

Generally the ribbons briefly described above have the only aim of enabling fastening (union of portions) or trimming operations (reinforcement, waterproofing, etc.) on the fabric and personalisation of same can only take place through modification of the respective colour.

The present invention aims at solving the above mentioned drawbacks.

It is an aim of the invention to make available a ribbon to be heat-sealed to fabrics which is differentiated from the already existing ribbons both from a functional and an aesthetic point of view, i.e. allowing new technical effects to be added to the manufactured article of clothing using such a ribbon, and also ensuring the possibility of important aesthetic effects that are of great importance in the clothes and fashion sector.

The foregoing and further aims that will become more apparent in the progress of the present description are substantially achieved by a ribbon for heat-sealing of fabrics in accordance with the appended claims.

Further features and advantages will become more apparent from the detailed description of some embodiments of a ribbon for heat-sealing in accordance with the invention.

This description will be carried out hereinafter with reference to the accompanying drawings given by way of non-limiting example, in which:

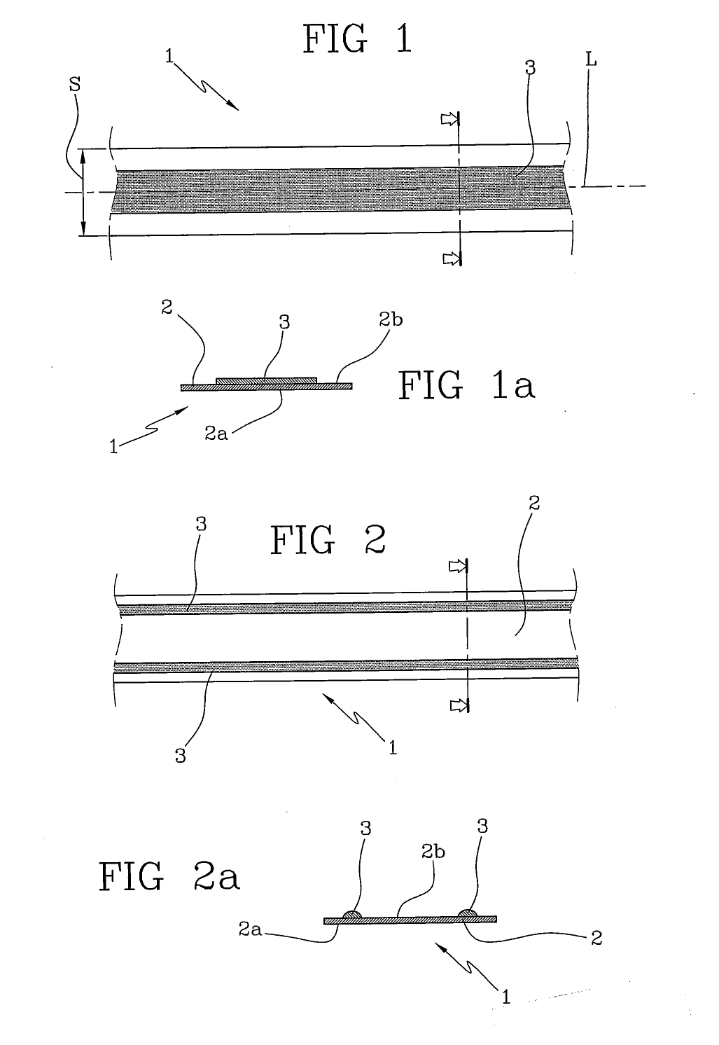

FIGS. 1, 2, 3, 4 show some alternative embodiments of a ribbon for heat-sealing of fabrics according to the present invention;

FIGS. 1a, 2a, 3a show respective cross sections of the ribbons seen in FIGS. 1, 2, 3;

FIG. 6 shows a garment by way of example, which is equipped with the heat-sealing ribbon in accordance with anyone of claims 1 to 4.

With reference to the drawings, a ribbon for heat-sealing of fabrics in accordance with the invention has been generally identified with reference numeral 1.

This ribbon will be used in combination with machines for heat-sealing and junction of fabrics that are presently on the market for carrying out trimming operations on fabrics or garments, or joining the edges or portions of these fabrics following generally conventional techniques not of interest in the present invention.

The ribbon first of all comprises at least one thin-sheet support 2 made of a polyurethane-based material and in particular made of a material suitable for being heat-sealed to a fabric. Generally, support 2 is made of a polyurethane material. This material not only enables heat-sealing, but in addition has elastic properties making it particularly suitable for coupling to fabrics also of different nature.

Depending on its particular composition, the polyurethane can also have such elastic features, i.e. stretching and spring-back features, that it can act like a true rubber band.

In addition, it can be obtained in different colours through addition of the appropriate pigment during production.

Alternatively, it can be also manufactured so as to appear substantially transparent or opaque.

Generally, the thin-sheet support 2 has a major longitudinal extension L and a smaller transverse size S, so as to take a ribbon-like configuration. It comprises a lower face 2a which is designed to come into contact with, and be heat-sealed to the fabric and a face 2b opposite to the preceding one.

The overall thickness of the thin-sheet support 2 is smaller than some tenths of a millimetre and is generally in the order of a hundredth of a millimetre.

Advantageously, the ribbon for heat-sealing shown in the drawings also comprises at least one layer 3 of silicone-based material disposed at least close to said upper face 2b of the support.

Generally, the material used for layer 3 can directly be silicone or, alternatively, once more a polyurethane material incorporating silicone material.

As can be viewed from FIGS. 1-4, layer 3 will be exclusively disposed at the upper face 2b of the support and in detail it will only cover some portions thereof so that part of the upper face 2b of the thin-sheet support 2 is in sight.

Generally, layer 3 of silicone-based material appears in the form of a continuous or broken strip exactly along the major longitudinal extension L of the thin-sheet support 2.

In this regard FIG. 1 shows a preferred embodiment in which layer 3 is made up of a central strip extending without a break in the longitudinal direction and disposed parallel to the edges of the thin-sheet support 2.

Alternatively, the presence of two or more layers 3 separated from each other and disposed on the upper face 2b of support 2 can be provided.

FIG. 2 shows the last-mentioned embodiment.

It is apparent that the single layer in FIG. 1 or the plurality of layers in FIG. 2 can be either continuous along the longitudinal extension or also interrupted (also a combination of continuous and interrupted lines is possible).

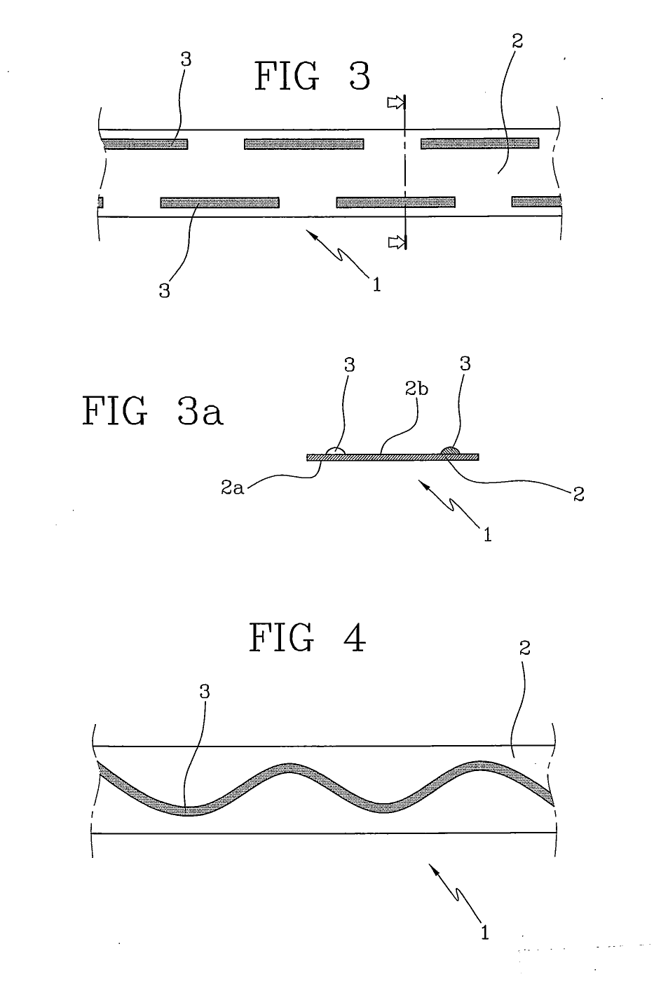

In this regard FIG. 3 shows a possible alternative embodiment showing interrupted longitudinal strips of silicone-based material 3.

It will be appreciated that laying of material 3 can take place, always along the major longitudinal direction L, with an undulated course (see FIG. 4) or also an irregular course depending on technical and aesthetic requirements of the product.

From a production point of view a possible manufacturing method will be hereinafter illustrated, but it is pointed out that other production procedures and/or devices could be equivalently adopted.

First of all, manufacture of said support 2 of polyurethane material in the form of a ribbon occurs.

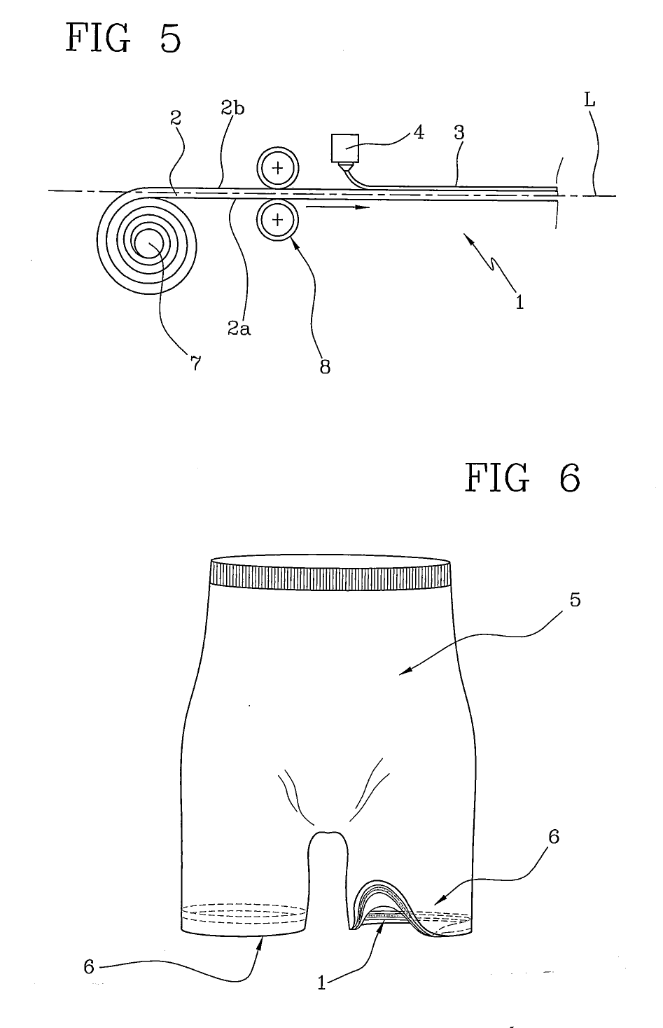

The latter, wound up into a reel as shown by reference in FIG. 5, is unrolled through suitable actuating means 8 such as rollers or the like and passed under one or more delivery nozzles 4 for direct laying of layer 3 made of a silicone-based material on the upper face 2b of the thin-sheet support 2.

It is apparent that if the silicone distribution is interrupted as the ribbon moves on along the longitudinal direction, interrupted silicone strips 3 will be obtained; on the contrary, if the delivery nozzles and the ribbon are shifted relative to each other in a transverse direction, during the forward movement of the ribbon itself, layers 3 will have different courses from the rectilinear one.

The product once made will have a lower face 2a made up of polyurethane material which is adapted to be directly bound to the fabric or fabric portion; vice versa, the upper portion will have one or more continuous or interrupted strips of silicone material provided with a glossy surface finish that is different from the surface finish of the upper face 2b of the support 2; the laid material further has higher friction and grip properties as compared with those of the polyurethane material.

In addition to the above mentioned aesthetic aims, the presence of the layer/s of silicone material has the function of increasing friction so that, for instance in sports or technical garments, the article of clothing is prevented from moving, once worn.

By mere way of example, FIG. 6 shows an article of clothing 5 provided with at least one portion of fabric 6 on which the ribbon referred to in FIGS. 1-4 is heat-sealed.

This article of clothing can consist of a pair of cyclist's shorts for example, where the ribbon is heat-sealed at least at the end region of the leggings, the lower face 2b being heat-sealed to fabric 6 and the upper face 2a facing a region designed to come into contact with the user's legs.

In this way, once the shorts are worn, the layer of silicone material will help in preventing the article of clothing from moving relative to the position taken when worn.

The invention achieves important advantages.

First of all a ribbon for heat-sealing of fabrics has been obtained which has further particular technical functions different from those of the ribbons presently used and on the market.

The presence of a layer (or more layers) of silicone material helps in greatly varying the aesthetic effect of the ribbon at will, because the silicone material appears to be glossier and of a colour different from the base layer of polyurethane material.

In addition, due to the presence of the silicone, technical articles of clothing can be made which are able to maintain or ensure the position they have taken, once worn.

1. A ribbon to be heat-sealed to textiles or fabrics, comprising at least one laminar support (2) of a polyurethane-based material suitable for heat-sealing to a fabric, said support comprising a lower face (2a) designed to come into contact with and be heat-sealed to a fabric, and an upper face (2b) opposite to the lower face, characterised in that it further wherein the ribbon further comprises at least one layer (3) of silicone-based material disposed at least at said upper face (2b) of the support (2), wherein said layer (3) of silicone-based material has higher friction and grip properties as compared with those of the polyurethane-based material, at least one portion of the upper face (2b) of the laminar support (2) that is not covered by the layer (3) of a silicone-based material being designed to remain in sight, together with the layer of silicone-based material, under conditions of application of the ribbon to a fabric.

2. A ribbon as claimed in claim 1, wherein the support (2) has a major longitudinal extension (L), said layer (3) of a silicone-based material having a prevailing arrangement along said longitudinal extension (L).

3. A ribbon as claimed in claim 1, wherein the layer of silicone-based material appears in, the form of a continuous, or broken strip, along the major longitudinal extension (L) of the laminar support (2).

4. A ribbon as claimed in claim 1, wherein the ribbon comprises at least two layers (3), preferably in the form of continuous or broken strips along the major longitudinal extension (L) of the laminar support, arranged on said upper face (2b) of the support (2).

5. A ribbon as claimed in claim 1, wherein the layer or layers (3) of silicone-based material cover the upper face (2b) of the support (2) only partly, said layers being preferably absent at the lower face (2a) of the support.

6. A ribbon as claimed in claim 1, wherein said layer (3) of a silicone-based material being is preferably directly laid on the upper face (2b) of the laminar support (2), as said ribbon does not in particular comprise other layers or supports except for the laminar support (2) and the silicone layer/s (3).

7. An article of clothing (5) comprising:
at least one portion of fabric (6);
wherein the article of clothing further comprises at least one ribbon (1) as claimed in claim 1, heat-sealed to said portion of fabric (6) wherein at least one portion of the upper face (2b) of the laminar support (2) that is not covered by the layer (3) of a silicone-based material remain in sight, together with the layer of silicone-based material, so that the article of clothing is prevented from moving, once worn.

8. An article of clothing (5) as claimed in claim 7, wherein the upper face (2b) of the laminar support (2) is heat-sealed to the fabric (6), the upper face (2a) comprising the layer (3) of silicone-based material facing away from the fabric to which the laminar support (2) is bound and in particular towards a region designed to come into contact with the article's user.

9. A process for producing a ribbon (1) suitable for heat-sealing to fabrics, comprising the following steps:
forming a laminar support (2) having a major longitudinal extension, made up of a polyurethane-based material; said support comprising a lower face (2a) designed to come into contact with and be heat-sealed to a fabric and an upper face (2b) opposite to the lower face;
causing said laminar support (2) to move forward along its major longitudinal extension direction (L) close to one or more delivery nozzles (4);
laying, by means of said one or more delivery nozzles (4), one or more layers (3) of silicone-based material on the upper face (2b) of said laminar support (2) moving along its major longitudinal extension direction (L).
